(19) United States
(12) Patent Application Publication
(10) Pub. No.: US 2005/0229162 A1
(43) Pub. Date: Oct. 13, 2005

(54) Systems and methods for providing multi-environment test automation

(75) Inventor: Carelton Tanner JR., Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/814,067

(22) Filed: Mar. 31, 2004

(51) Int. Cl. G06F 9/44

(52) U.S. Cl. 717/126

(57) ABSTRACT

The present invention is directed to a multi-environment test automation (META) driver, that is, a test automation driver that can be used in multiple environments such as, for example, to test HTTP calls as well as relational database statements in SQL, in order to provide a flexible, extensible framework for test components so that a single driver can span multiple test environments. Certain embodiments further enable best practices to be formalized on a per environment basis, while certain other embodiments will provide a unified interface for authoring new tests.

### TECHNICAL FIELD

The present invention relates generally to software development and, more particularly, to test automation drivers used to test HTTP calls, relational database statements, etc.

### BACKGROUND

As known and appreciated by those of skill in the art, “alpha testing” generally refers to the first phase of testing in a software development process. This first phase usually includes unit testing, component testing, and system testing. In today's software development environments, automated testing tools, comprising one or more test automation drivers, are often employed to test software and software-related components.

However, due to the diversity and general incompatibility of software programming languages and platforms, test automation drivers tend to be very environment specific. For example, an HTTP test driver is used to test calls to the Hypertext Transfer Protocol (HTTP), a Sequential Query Language (SQL) driver is used to test only SQL statements (in database environments or other environments that use database-style queries), and so on and so forth. However, many of the tests performed across these diverse platforms are similar if not identical. Therefore, the plurality of existing test drivers usually re-implement common infrastructure in separate automated testing drivers necessary to accommodate the diversity of environments.

What is need in the art is a flexible, extensible framework for test components so that a single test driver can span multiple test environments. Such a system would preferably still allow for best practices to be formalized on a per environment basis, and would also provide a unified interface for authoring tests for multiple environments.

### SUMMARY

Various embodiments of the present invention are directed to multi-environment test automation (META) drivers, that is, test automation drivers that can be used in multiple environments such as, for example, to test HTTP calls as well as relational database statements in SQL. These META drivers, in turn, will provide a flexible, extensible framework for test components so that a single driver can span multiple test environments.

Certain embodiments of the present invention further allow for best practices to be formalized on a per environment basis, while certain other embodiments will provide a unified interface for authoring tests.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2 is a block diagram illustrating the four basic and one optional component parts to the META System 200; and

FIG. 3 is a block diagram illustrating Test execution flow for several embodiments of the present invention.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

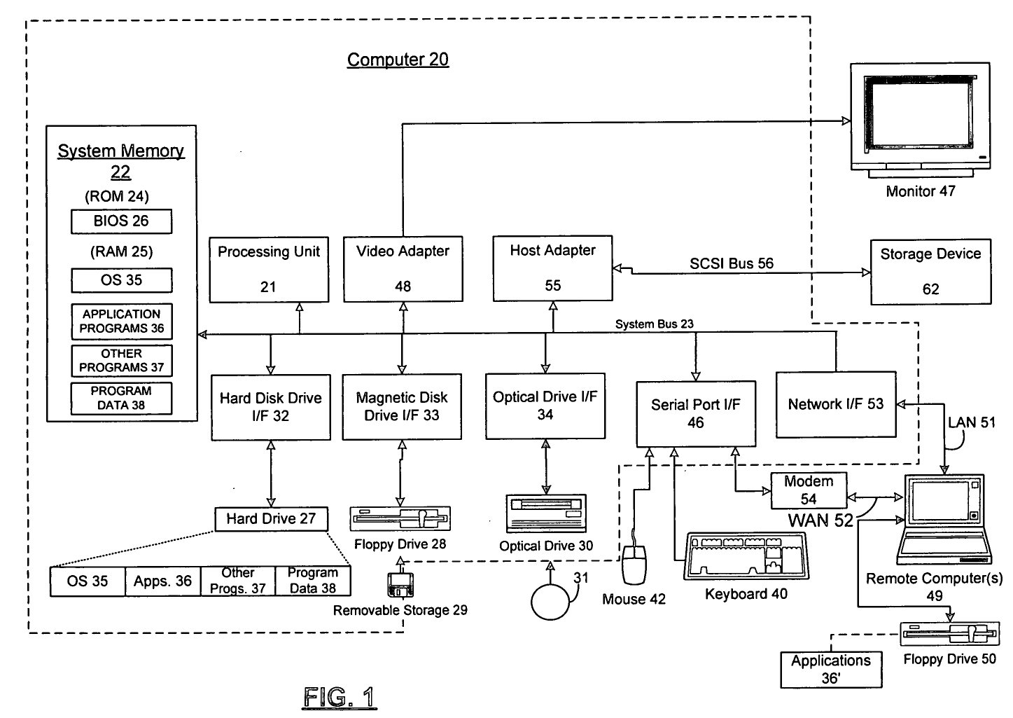

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

While it is envisioned that numerous embodiments of the present invention are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

Multi-Environment Testing Automation (META)

As previously discussed, there is a need in the art for flexible testing automation that allows testers to operate in a plurality of environments which may provide an easy-to-use system that provides testers with an ability to write and execute Tests (discussed in detail herein below) quickly and efficiently in multiple environments. Such an system, having a unified interface, might also be able to reduce the cost of maintaining Tests over time and across releases of the software being tested, not to mention the fact that maintaining Tests in a common format would enable those Tests to be leveraged by different groups working in diverse environments.

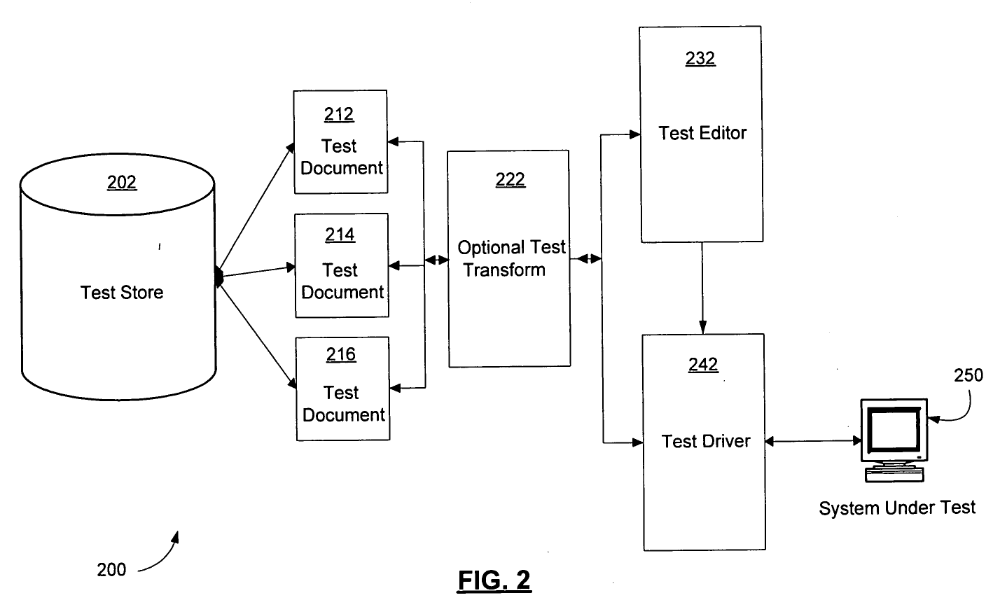

Various embodiments of the present invention comprise the META system and META methods disclosed herein. For several embodiments of the present invention, the META system comprises four parts: a Test Store, a Test Document, a Test Driver, and a Test Editor. In certain alternative embodiments, the META system may also comprise an optional Test Transform. FIG. 2 is a block diagram illustrating the four basic and one optional component parts to the META System 200.

Referring to FIG. 2, the Test Store 202 is a repository for specific Tests. The Test Store 202 may allow groups of Tests to be organized hierarchically, for example, organized in folders where the folders can be annotated with information about the Tests they contain. In certain embodiments, the organization of these Tests may be automatically updated based on a variety of criteria including but not limited to the manner in which the Tests are executed, the frequency in which the Tests are executed, or the most common environment(s) in which the Tests are executed.

In specific embodiments, the Test Store 202 is implemented as an abstraction that allows Test Documents 212, 214, and 216 (discussed in detail later herein) to be stored in different formats. Thus, in operation, the Test Store 202 might be able to save Test Documents 212, 214, and 216 into, for example, a database, a file share, and change tracking system respectively. The Test Store 202 might also provide services for browsing, saving and retrieving the Test Documents 212, 214, and 216, among other things.

Test Documents 212, 214, and 216 are each semi-structured data objects that describe the nature of each Test (what the Test does, how it does it, etc.) and further provide information regarding the means necessary to verify results including a description of what correct results should look like.

The optional Test Transform 222 would allow existing Tests (embodied in the Test Documents 212, 214, and 216) to be leveraged and transformed into different Tests (and possibly into new Test Documents altogether). For example, a functional Test in a first Test Document 212 may be transformed into a stress Test for a second Test Document 214.

The Test Driver 232 interprets the Test Documents 212, 214, and 216 and (a) execute the corresponding Tests and (b) verifies whether the Test has passed or failed. If a Test fails, the driver provides information so that it can be determined why the Test failed.

The Test Editor 242 enables a user to author Test Documents (e.g., Test Document 212) for inclusion in the Test System. In certain embodiments, the Test Editor 242 can also call the Test Driver 232 to execute Tests as they are drafted.

Testing

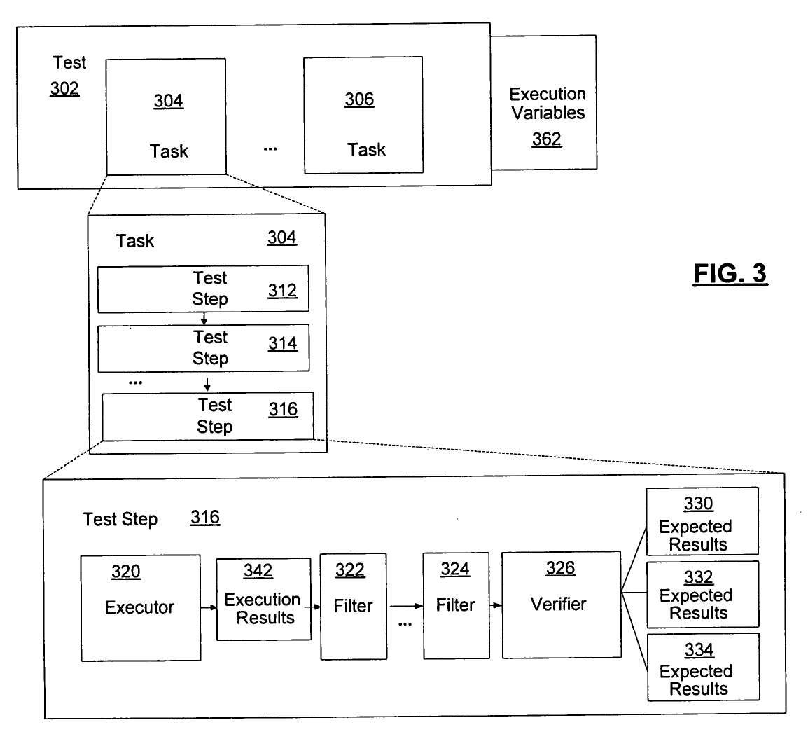

Using a META system—and referring to FIG. 3 which is a block diagram illustrating Test execution flow for several embodiments of the present invention—a Test 302 may be comprised of parallel Tasks 304-306, each Task (e.g., Task 304) contains one or more sequential Steps 310, 312, and 314, where each Step (e.g., Step 316) is composed of an Executor 320, zero or more Filters 322-324, a Verifier 326, and one or more sets of Expected Results 330, 332, and 334. In use, execution variables provide parameterized data to the test when executed. Moreover, multiple Tasks 304-306 may be used to create multi-threaded tests (MTTs) (not shown), and each Task (e.g., Task 304) may run concurrently with all other Tasks (e.g., Task 306) in the Test (e.g., Test 302). Thus each Step (e.g., Step 316) represents an action to take in a specific environment.

For each Test 302, the Executor 320 is responsible for executing the Steps 312, 314, and 316 and generating some useful output, a.k.a, the Execution Results 342. The Execution Results 342 are then passed through zero or more Filters 322-324 and then passed to the Verifier 326. The Verifier 326 compares the results generated by the Executor 320 to some Expected Results (e.g., Expected Results 330) that were generated previously and determines whether the Step 316 has passed or failed. Generally, if any Step 312, 314, and 316 fails in the Test 302, then the Test 302 itself fails.

Execution Variables 362 can be used to supply data that changes frequently to the Test 302 so that this information does not need to be hard coded into the Test 302. Finally, in certain embodiments there may be a generic synchronization mechanism (not shown) that coordinates the execution of multi-task tests (not shown).

For several embodiments of the present invention, Executors 320, Filters 322-324, and Verifiers 326 could be developed as stand-alone components created and customized by different test teams. Examples of Executors 320 may include but are not limited to ones that compile managed code, issue SQL queries, send SOAP HTTP requests, launch executables, and write files to persistent storage (e.g., a hard disk). Examples of Filters 322-324 may include but are not limited to the regular expression search, replace, and XSL/T transforms of XML data. Examples of currently implemented Verifiers 326 may include but are not limited to checksum verification, text comparison, XML comparison, and performance comparison. As will be readily understood and appreciated by those of skill in the art, these and several other components described herein comprising the invention can utilize various existing technologies and techniques that are well-established in the art, and the utilization of such components is naturally anticipated as comprising several additional embodiments of the present invention.

### CONCLUSION

The various system, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

1. A system for multi-environment testing automation comprising:
a Test Store in which a at least one Test is stored;
a Test Document that describes at least one Test that can be executed in at least two testing environments; and
a Test Driver that interprets said Test Document to execute at least one Test described by said Test Document.

2. The system of claim 1 wherein said one Test that is described by said Test Document can be executed in an HTTP environment and one additional environment.

3. The system of claim 1 wherein said one Test that is described by said Test Document can be executed in a SQL environment and one additional environment.

4. The system of claim 1 further comprising at least one Execution Variable corresponding to said Test and comprising data that does not comprise data in said Test.

5. The system of claim 1 further comprising a Test Editor for authoring a Test Document.

6. The system of claim 1 further comprising a Test Transform that would transform an existing Test in a first Test Document into a new Test in a second Test Document.

7. A system for executing Tests, said Tests comprising at least one Task where each of said at least one Task comprises at least one Step, said system comprising:
an Executor subsystem that executes at least one Step and generates at least one Execution Result; and
a Verifier for comparing at least one Execution Result to at least one Expected Result.

8. The system of claim 7 further comprising a Filter for filtering at least one Execution Result generated by said Executor before said at least one Execution Result is compared by said Verifier to said at least one Expected Result.

9. A method of testing automation in a plurality of environments, said method comprising:
grouping at least one Test into a Test Store, said Test Store comprising data pertaining to Tests it contains, said Test being able to be executed in at least two environments;
describing a nature of at least one Test in at least one Test Document, wherein said nature comprises information regarding a means for verifying a result derived from said Test and a description of what constitutes a correct results for said Test;
interpreting at least one Test Documents to execute at least one Test verifying whether said at least one Test passes or fails.

10. The method of claim 9 further comprising the utilization least one Execution Variable corresponding to said Test and comprising data that does not comprise data in said Test.

11. The method of claim 9 further comprising transforming a Test in a first Test Document into a new Test for a second Test Document.

12. The method of claim 9 wherein said Test Store is implemented as an abstraction that allows a plurality of Test Documents to be stored in at least two different formats.

13. The method of claim 9 wherein said Test Store further comprises functionality for browsing, saving, and retrieving a Test Document.

14. The method of claim 9 wherein an organization of Tests in a Store Test is automatically updated based on at least one criteria from among the following plurality of criteria: the manner in which one or more Tests are executed; the frequency in which one or more Tests are executed; and the most common environment in which one or more Tests are executed.

15. A computer-readable medium comprising computer-readable instructions for:
a Test Store in which a at least one Test is stored;
a Test Document that describes at least one Test that can be executed in at least two testing environments; and
a Test Driver that interprets said Test Document to execute at least one Test described by said Test Document.

16. The computer-readable instructions of claim 15 further comprising instructions for executing said one Test that is described by said Test Document in an HTTP environment and one additional environment.

17. The computer-readable instructions of claim 15 further comprising instructions for executing said one Test that is described by said Test Document in a SQL environment and one additional environment.

18. The computer-readable instructions of claim 15 further comprising instructions whereby at least one Execution Variable corresponding to said Test and comprising data that does not comprise data in said Test is utilized in executing said Test.

19. The computer-readable instructions of claim 15 further comprising instructions for a Test Editor to author a Test Document.

20. The computer-readable instructions of claim 15 further comprising instructions for a Test Transform for transforming an existing Test in a first Test Document into a new Test in a second Test Document.

21. The computer-readable instructions of claim 15, wherein at least one Test comprises at least one Task, and wherein each of said at least one Task comprises at least one Step, said computer-readable instructions further comprising instructions for:
an Executor subsystem that executes at least one Step and generates at least one Execution Result; and
a Verifier for comparing at least one Execution Result to at least one Expected Result.

22. The computer-readable instructions of claim 21 further comprising instructions for a Filter for filtering at least one Execution Result generated by said Executor before said at least one Execution Result is compared by said Verifier to said at least one Expected Result.

23. The computer-readable instructions of claim 15 further comprising instructions for:
grouping at least one Test into a Test Store, said Test Store comprising data pertaining to Tests it contains, said Test being able to be executed in at least two environments;
describing a nature of at least one Test in at least one Test Document, wherein said nature comprises information regarding a means for verifying a result derived from said Test and a description of what constitutes a correct results for said Test;
interpreting at least one Test Documents to execute at least one Test verifying whether said at least one Test passes or fails.

24. The computer-readable instructions of claim 23 further comprising instructions for utilizing least one Execution Variable corresponding to said Test and comprising data that does not comprise data in said Test.

25. The computer-readable instructions of claim 23 further comprising instructions for transforming a Test in a first Test Document into a new Test for a second Test Document.

26. The computer-readable instructions of claim 23 further comprising instructions for implementing said Test Store as an abstraction that allows a plurality of Test Documents to be stored in at least two different formats.

27. The computer-readable instructions of claim 23 further comprising instructions for browsing, saving, and retrieving a Test Document.

28. The computer-readable instructions of claim 23 further comprising instructions for automatically updating an organizational structure for a plurality of Tests in a Test Document based on at least one criteria from among the following plurality of criteria: the manner in which one or more Tests are executed; the frequency in which one or more Tests are executed; and the most common environment in which one or more Tests are executed.
